(19) United States
(12) Patent Application Publication
(10) Pub. No.: US 2026/0193990 A1
(43) Pub. Date: Jul. 9, 2026

(54) APPARATUS TO REDUCE VIBRATION OF SEAL SEGMENTS FOR A GAS TURBINE ENGINE

(71) Applicant: General Electric Company, Evendale, OH (US)

(72) Inventors: David Raju Yamarthi, Bengaluru (IN); Ravindra Shankar Ganiger, Bengaluru (IN); Deepak Trivedi, Halfmoon, NY (US); Rahul A Bidkar, Clifton Park, NY (US); Steven Douglas Johnson, Millford, OH (US)

(21) Appl. No.: 19/012,497

(22) Filed: Jan. 7, 2025

(51) Int. Cl. F01D 11/16; F01D 25/04

(52) U.S. Cl. CPC F01D 11/16; F01D 25/04; F05D 2260/96

(57) ABSTRACT

An apparatus to reduce vibration of seal segments for a gas turbine engine is disclosed. An example apparatus includes a rotor, a stator, and a radial seal positioned between the rotor and the stator, the radial seal including a plurality of seal segments spanning a circumference of the rotor, a quantity of the plurality of seal segments corresponding to a prime number.

### FIELD OF THE DISCLOSURE

This disclosure relates generally to sealing in gas turbine engines and, more particularly, to an apparatus to reduce vibration of seal segments for a gas turbine engine.

### BACKGROUND

Gas turbine engines, such as turbofan engines, may be used for aircraft propulsion. A turbofan engine generally includes a bypass fan section and a turbomachine such as a gas turbine engine to drive the bypass fan. The turbomachine generally includes a compressor section, a combustion section, and a turbine section in a serial flow arrangement. The compressor section and the turbine section are driven by one or more rotor shafts and generally include multiple rows or stages of rotor blades coupled to the rotor shaft. A row of rotor blades is axially spaced from a successive row of rotor blades by a respective row of stator or stationary vanes. A radial gap is formed between an inner surface of the stator vanes and an outer surface of the rotor shaft.

### BRIEF DESCRIPTION OF THE DRAWINGS

FIG. 1 is a schematic cross-sectional view of an example high-bypass turbofan-type gas turbine engine in which examples disclosed herein may be implemented.

FIG. 2 is a cross-sectional view of an example radial seal that may be implemented in the example gas turbine engine of FIG. 1.

FIG. 3 is a cross-sectional view of a second example radial seal with example seal segments having respective different circumferential widths.

FIG. 4 is a cross-sectional view of a third example radial seal with seal segments having respective different radial thicknesses.

FIG. 5 is a cross-sectional view of a fourth example radial seal with seal segments having an alternating pattern.

FIG. 6 is a cross-sectional view of a fifth example radial seal with seal segments having a graded pattern.

FIG. 7 is a cross-sectional view of a sixth example radial seal with seal segments having a cyclical pattern.

FIG. 8 is a cross-sectional view of a seventh example radial seal with seal segments having an offset radius.

FIG. 9 is a cross-sectional view of an eighth example radial seal with seal segments having multiple different dimensions.

FIG. 10 is a cross-sectional view of an example seal segment of FIG. 2 taken along line A-A of FIG. 2.

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

### DETAILED DESCRIPTION

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “substantially,” “approximately,” and “about” modify their subjects/values to recognize the potential presence of variations that occur in real world applications. For example, “substantially,” “approximately,” and “about” may modify dimensions that may not be exact due to manufacturing tolerances and/or other real world imperfections as will be understood by persons of ordinary skill in the art. For example, “substantially,” “approximately,” and “about” may indicate such dimensions may be within a tolerance range of +/−10% unless otherwise specified herein.

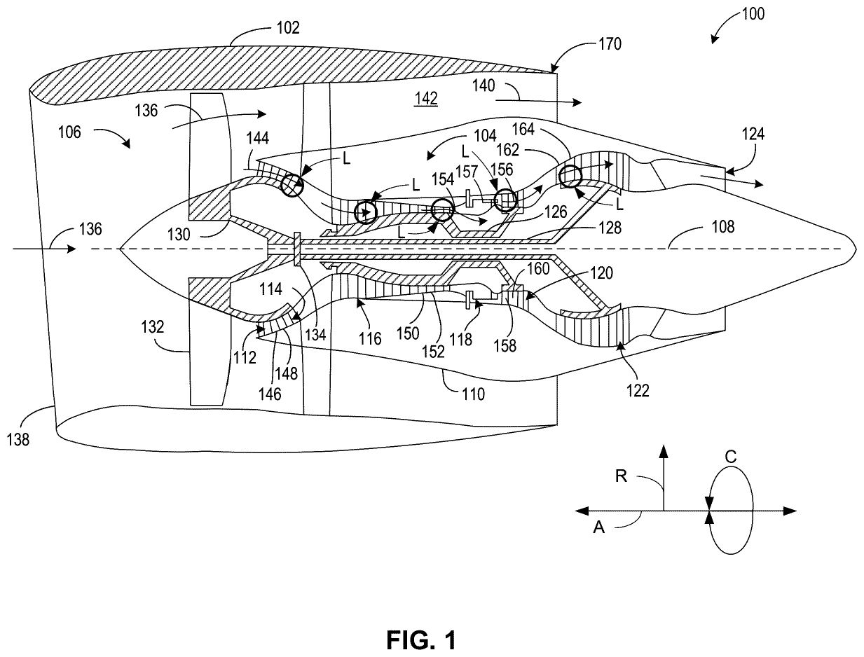

FIG. 1 is a schematic cross-sectional view of an example gas turbine engine 100 that can incorporate various examples disclosed herein. The example gas turbine engine 100 can be implemented on an aircraft and therefore referred to as an aircraft engine. In this example, the gas turbine engine 100 is a turbofan-type of engine. However, the principles of the present disclosure are also applicable to other types of engines, such as turboprop engines and engines without a nacelle, such as unducted fan (UDF) engines (sometimes referred to as propfans). Further, the examples disclosed herein can be implemented on other types of engines, such as non-aircraft engines, and/or power generators.

As shown in FIG. 1, the gas turbine engine 100 includes an outer bypass duct 102 (which may also be referred to as a nacelle, fan duct, or outer casing), a core turbine engine 104, and a fan section 106. The core turbine engine 104 and the fan section 106 are disposed at least partially in the outer bypass duct 102. The core turbine engine 104 is disposed downstream from the fan section 106 and drives the fan section 106 to produce forward thrust.

As shown in FIG. 1, the gas turbine engine 100 defines a longitudinal or axial centerline axis 108 extending therethrough for reference. FIG. 1 also includes an annotated directional diagram with reference to an axial direction A, a radial direction R, and a circumferential direction C. As used herein, the axial direction A is a direction that extends generally parallel to the centerline axis 108, the radial direction R is a direction that extends orthogonally outward from or inward toward the centerline axis 108, and the circumferential direction C is a direction that extends concentrically around the centerline axis 108. Further, as used herein, the term “forward” refers to a direction along the centerline axis 108 in the direction of movement of the gas turbine engine 100, such as to the left in FIG. 1, while the term “rearward” refers to a direction along the centerline axis 108 in the opposite direction, such as to the right in FIG. 1.

The core turbine engine 104 includes a substantially tubular outer casing 110 (which may also be referred to as a mid-casing) that defines an annular inlet 112. The outer casing 110 of the core turbine engine 104 can be formed from a single casing or multiple casings. The outer casing 110 encloses, in serial flow relationship, a compressor section having a booster or low pressure compressor 114 (“LP compressor 114”) and a high pressure compressor 116 (“HP compressor 116”), a combustion section 118 (which may also be referred to as the combustor 118), a turbine section having a high pressure turbine 120 (“HP turbine 120”) and a low pressure turbine 122 (“LP turbine 122”), and an exhaust section 124.

The core turbine engine 104 includes a high pressure shaft 126 (“HP shaft 126”) that drivingly couples the HP turbine 120 and the HP compressor 116. The core turbine engine 104 also includes a low pressure shaft 128 (“LP shaft 128”) that drivingly couples the LP turbine 122 and the LP compressor 114. The LP shaft 128 also couples to a fan shaft 130.

The fan section 106 includes a plurality of fan blades 132 that are coupled to and extend radially outward from the fan shaft 130. In some examples, the LP shaft 128 may couple directly to the fan shaft 130 (i.e., a direct-drive configuration). In alternative configurations, the LP shaft 128 may couple to the fan shaft 130 via a reduction gear 134 (i.e., an indirect-drive or geared-drive configuration). While in this example the core turbine engine 104 includes two compressors and two turbines, in other examples, the core turbine engine 104 may only include one compressor and one turbine. Further, in other examples, the core turbine engine 104 can include more than two compressors and turbines. In such examples, the core turbine engine 104 may include more than two drive shafts or spools.

As illustrated in FIG. 1, during operation of the gas turbine engine 100, air 136 enters an inlet portion 138 of the gas turbine engine 100. The air 136 is accelerated by the fan blades 132. A first portion 140 of the air 136 flows into a bypass airflow passage 142, while a second portion 144 of the air 136 flows into the annular inlet 112 of the core turbine engine 104 (and, thus, into the LP compressor 114). Downstream of the annular inlet 112, one or more sequential stages of LP compressor stator vanes 146 and LP compressor rotor blades 148 coupled to the LP shaft 128 progressively compress the second portion 144 of the air 136 flowing through the LP compressor 114 en route to the HP compressor 116. Next, one or more sequential stages of HP compressor stator vanes 150 and HP compressor rotor blades 152 coupled to the HP shaft 126 further compress the second portion 144 of the air 136 flowing through the HP compressor 116. This provides compressed air 154 to the combustion section 118 where it mixes with fuel and burns to provide combustion gases 156. Fuel is injected into the combustion section 118 by one or more nozzles 157. The gas turbine engine 100 includes a fuel system to provide pressurized fuel through the nozzles 157 to the combustion section 118 of the core turbine engine 104.

The combustion gases 156 flow through the HP turbine 120 where one or more sequential stages of HP turbine stator vanes 158 and HP turbine rotor blades 160 coupled to the HP shaft 126 extract a first portion of kinetic and/or thermal energy. This energy extraction supports operation of the HP compressor 116. The combustion gases 156 then flow through the LP turbine 122 where one or more sequential stages of LP turbine stator vanes 162 and LP turbine rotor blades 164 coupled to the LP shaft 128 extract a second portion of thermal and/or kinetic energy therefrom. This energy extraction causes the LP shaft 128 to rotate, which supports operation of the LP compressor 114 and/or rotation of the fan shaft 130. The combustion gases 156 then exit the core turbine engine 104 through the exhaust section 124 thereof. The combustion gases 156 mix with the first portion 140 of the air 136 from the bypass airflow passage 142. The combined gases exit an exhaust nozzle 170 (e.g., a converging/diverging nozzle) of the bypass airflow passage 142 to produce propulsive thrust.

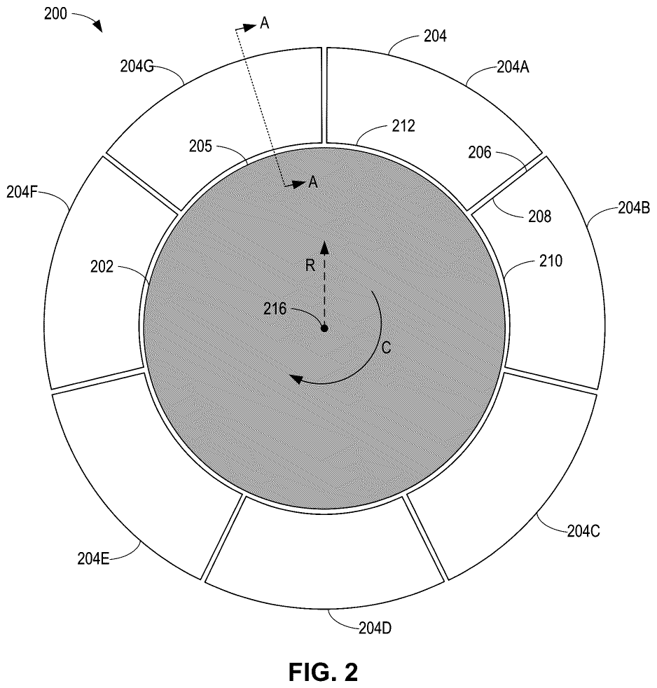

In some examples, one or more seals (e.g., radial seals, hybrid radial seals, film-riding seals, etc.) may be implemented in the gas turbine engine 100 to restrict flow and/or leakage of fluid between high-pressure and low-pressure regions of the gas turbine engine 100. For example, FIG. 2 is a cross-sectional view of an example radial seal (e.g., a hybrid radial seal, a segmented seal, a film-riding seal) 200 that may be implemented in the example gas turbine engine 100 of FIG. 1. In the illustrated example of FIG. 2, the radial seal 200 is implemented on and/or operatively coupled to an example rotor (e.g., a rotor shaft) 202. In some examples, the rotor 202 corresponds to a rotor of the gas turbine engine 100 of FIG. 1, such as the HP shaft 126, the LP shaft 128, etc. For example, referring back to FIG. 1, example locations (e.g., labelled L) at which the radial seal 200 of FIG. 2 may be implemented are shown in FIG. 1.

Returning to FIG. 2, the radial seal 200 includes multiple example seal segments (e.g., radial seal segments) 204 spaced about and/or spanning a circumference (e.g., a circumferential surface) 205 of the rotor 202. For example, the radial seal 200 of FIG. 2 includes a first seal segment 204A, a second seal segment 204B, a third seal segment 204C, a fourth seal segment 204D, a fifth seal segment 204E, a sixth seal segment 204F, and a seventh seal segment 204G. In some examples, adjacent seal segments 204 (e.g., the first and second seal segments 204A, 204B, the second and third seal segments 204B, 204C, etc.) are coupled together at one or more locations along respective edges and/or side surfaces 206 of the seal segments 204. In some examples, the radial seal 200 can include gaps (e.g., inter-segment gaps) 208 between the adjacent seal segments 204, and can further include a radial gap 210 between the seal segments 204 and the rotor 202.

In the illustrated example of FIG. 2, the radial seal 200 includes an example film (e.g., a gas film, an air film, a fluid bearing) 212 positioned in the radial gap 210 between the seal segments 204 and the rotor 202. In some examples, the film 212 enables rotation of the rotor 202 in the circumferential direction C about a longitudinal axis 216 of the rotor 202 (e.g., extending out of the page in FIG. 2) while restricting flow and/or leakage of fluid between a high-pressure region and a low-pressure region of the gas turbine engine 106 of FIG. 1. In some examples, the film 212 can maintain a separation between the rotor 202 and the seal segments 204 to reduce friction therebetween and, as a result, reduce wear of the seal segments 204 and/or the rotor 202 during operation of the gas turbine engine 106.

In some examples, vibration of the rotor 202 and/or the seal segments 204 may occur during operation of the gas turbine engine 106 of FIG. 1. For example, when the rotor 202 rotates in the circumferential direction C, the rotor 202 may expand (e.g., in the radial direction R) as a result of centrifugal growth and/or changes in temperature of the rotor 202. Additionally or alternatively, a radial dimension of the rotor 202 (e.g., between the longitudinal axis 216 and the circumference 205 of the rotor 202) may vary in the circumferential direction C (e.g., as a result of manufacturing tolerances and/or misalignment between components of the gas turbine engine 106). In some examples, the seal segments 204 follow (e.g., ride on) the film 212 and, thus, the circumference 205 of the rotor 202 during rotation of the rotor 202, such that variations in the radial dimension of the rotor 202 may result in vibration of the seal segments 204 along the radial direction R (e.g., toward and/or away from the longitudinal axis 216 of the rotor 202). In some examples, such vibration may result in undesired contact between the seal segments 204 and the rotor 202, which may cause damage to the rotor 202 and/or to one or more components of the gas turbine engine 106.

In some examples, vibratory loads applied to the rotor 202 can excite vibration of one or more of the seal segments 204 when the applied loads are at or near a natural frequency of the one or more seal segments 204. As used herein, “natural frequency” refers to a frequency at which an object tends to vibrate as a result of a disturbance (e.g., an applied force). In some examples, the seal segments 204 have corresponding natural frequencies (and/or sets of natural frequencies) associated therewith, where the natural frequencies are based on a mass and/or a stiffness of the seal segments 204.

For example, the seal segments 204 can have different natural frequencies corresponding to respective different modes and/or mode shapes (e.g., a rolling mode, a bending mode, etc.).

In some examples, the rotor 202 can experience cyclic vibration during operation of the gas turbine engine 106. For example, imbalances in the mass and/or geometry of the rotor 202 may result in vibrations that occur once per revolution of the rotor 202 (e.g., 1-per rev vibrations), twice per revolution of the rotor 202 (e.g., 2-per rev vibrations), three times per revolution of the rotor 202 (e.g., 3-per rev vibrations), etc. In such examples, a frequency of the vibratory loads applied to the seal segments 204 are based on a rotation speed of the rotor 202 and a number of vibrations applied per revolution of the rotor 202. In some examples, when the frequency of the applied vibratory loads are substantially equal to the natural frequency of the seal segments 204, the applied vibratory loads can excite and/or induce vibration of the seal segments 204. Such vibration can reduce sealing efficiency of the seal segments 204, result in undesired contact between and/or damage to components of the gas turbine engine 106, etc.

Examples disclosed herein utilize seal segments that are resistant to excitation by vibratory loads generated during operation of the gas turbine engine 106. In examples disclosed herein, the radial seal can be made nonuniform and/or asymmetric by adjusting dimensions and/or material properties of one or more of the seal segments. For example, the dimensions can include at least one of a width (e.g., in the circumferential direction C), a length (e.g., in the axial direction A), or a thickness (e.g., in the radial direction R) of the seal segments. Further, the material properties can include at least one of a mass, a material composition, or a density (e.g., an effective density) of the seal segments. In some examples, the material properties can include at least one of a Poisson's ratio (e.g., a ratio of expansion along one axis to contraction along an opposite axis when a material is subject to tensile or compressive forces), an elastic modulus, and/or a stiffness (e.g., a lateral stiffness, a bending stiffness, and/or an axial stiffness) of the seal segments. In some examples, the dimensions and/or the material properties can be adjusted such that adjacent seal segments have respective different natural frequencies. As a result of the variations in natural frequency between adjacent seal segments, vibratory loads applied to one or more of the seal segments are unlikely to excite and/or induce vibration of adjacent seal segments. Accordingly, the radial seal can be less susceptible to resonant oscillations during operation of the gas turbine engine when nonuniform and/or asymmetric seal segments are implemented in the radial seal (e.g., compared to when the radial seal includes uniform seal segments having substantially the same natural frequencies).

Additionally or alternatively, a quantity of the seal segments can be selected to reduce a likelihood of oscillation (e.g., resonant oscillation) of the seal segments. For example, in FIG. 2, a quantity (e.g., a number, a count) of the seal segments 204 implemented in the radial seal 200 is a prime number (e.g., seven). While the radial seal 200 includes seven of the seal segments 204 in this example, the quantity of the seal segments 204 can be a different prime number (e.g., five, eleven, thirteen, seventeen, etc.) in some examples. As described further below, by implementing a prime number of the seal segments 204, the radial seal 200 of FIG. 2 can be more resistant to excitation by cyclical vibrations of the rotor 202 (e.g., per rev vibrations) compared to when a non-prime number of the seal segments 204 is used.

In some examples, resonance can occur when the number of seal segments is a multiple of the number of vibrations per revolution (rev) of the rotor 202. For example, when a 2-per rev vibratory load is applied to a radial seal having an even and/or non-prime number of seal segments (e.g., fourteen seal segments), synchronization between a frequency of the applied load and a natural frequency of the seal segments can occur, resulting in resonance. Conversely, when the 2-per rev vibratory load is applied to the radial seal 200 of FIG. 2, the number of the seal segments 204 (e.g., seven) is not divisible by the per-rev rate (e.g., two) of the applied load. As a result, a likelihood of synchronization (e.g., resonance) between the frequency of the applied vibratory load and the natural frequency of the seal segments 204 can be reduced.

In some examples, in addition to or instead of implementing a prime number of the seal segments 204, the radial seal 200 can include seal segments 204 having dimensions and/or material properties that vary in the circumferential direction C of the rotor 202. As used herein, “vary” or “varying” means have or having a standard deviation that is greater than or equal to a threshold percentage (e.g., 5 percent (%)) of a mean value.

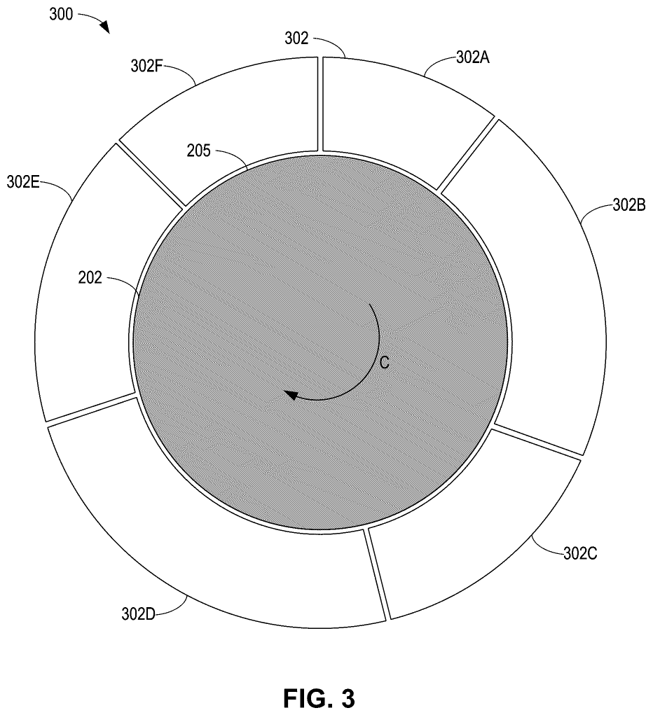

FIG. 3 illustrates a second example radial seal 300 that may be implemented on the rotor 202 of FIG. 2. In the illustrated example of FIG. 3, the second radial seal 300 includes a non-prime number (e.g., six) of example seal segments 302 (e.g., a first seal segment 302A, a second seal segment 302B, a third seal segment 302C, a fourth seal segment 302D, a fifth seal segment 302E, and a sixth seal segment 302F) spanning the circumference 205 of the rotor 202. While, in this example, the second radial seal 300 includes six of the seal segments 302, in other examples, the second radial seal 300 can include a different number (e.g., five or less, seven or more) of the seal segments 302.

In the illustrated example of FIG. 3, the seal segments 302 have respective different widths (e.g., circumferential widths) in the circumferential direction C of the rotor 202. Stated differently, the seal segments 302 span respective different distances along the circumference 205 of the rotor 202. In this example, the widths of the seal segments 302 are randomly distributed along the circumference 205, with a standard deviation of the widths being at least 5 percent and up to 100 percent of a mean value of the widths along the circumference 205. In some examples, at least two of the seal segments 302 (e.g., non-adjacent seal segments) can have substantially the same width. In the illustrated example of FIG. 3, as a result of the variations in width, the seal segments 302 have respective different natural frequencies, which can reduce and/or inhibit excitation of vibrations between adjacent seal segments 302.

In some examples, one or more material properties may differ between two or more of the seal segments 302. For example, at least two of the seal segments 302 can have respective different masses, densities, and/or material compositions. In some examples, at least one material property (e.g., mass and/or density) of the seal segments 302 is randomly distributed along the circumference 205, with a standard deviation of the at least one material property being at least 5 percent and up to 20 percent of a mean value of the at least one material property along the circumference 205. In some examples, the seal segments 302 can have different natural frequencies resulting from the variation in material properties (e.g., in addition to the variations in circumferential width of the seal segments 302). In some examples, one or more different dimensions associated with the seal segments 302 (e.g., in addition to or instead of the width) can be adjusted to adjust the natural frequencies of adjacent seal segments 302. Further, while the circumferential widths of the seal segments 302 are randomly distributed along the circumference 205 of the rotor 202, the circumferential widths can be distributed at least one of linearly, logarithmically, or exponentially along the circumference 205.

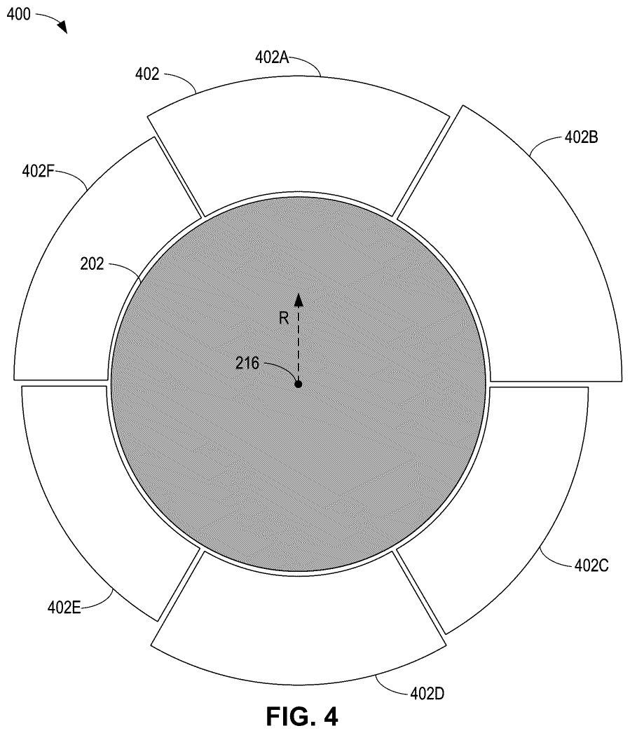

FIG. 4 illustrates a third example radial seal 400 that may be implemented on the rotor 202 of FIG. 2. In the illustrated example of FIG. 4, the third radial seal 400 includes six example seal segments 402 (e.g., including a first seal segment 402A, a second seal segment 402B, a third seal segment 402C, a fourth seal segment 402D, a fifth seal segment 402E, and a sixth seal segment 402F) spanning the circumference 205 of the rotor 202. In this example, the seal segments 402 have respective different thicknesses (e.g., radial thicknesses) measured in a radial direction R from the longitudinal axis 216 of the rotor 202. In some examples, the thicknesses of the seal segments 402 are randomly distributed along the circumference 205, with a standard deviation of the thicknesses being at least 5 percent and up to 100 percent of a mean value of the thicknesses along the circumference 205. In some examples, at least two of the seal segments 402 (e.g., non-adjacent seal segments) can have substantially the same thickness. In the illustrated example of FIG. 4, as a result of the variations in thickness, the seal segments 402 can have respective different natural frequencies, which can reduce and/or inhibit excitation of vibrations between adjacent seal segments 402. Further, while the thicknesses of the seal segments 402 can be randomly distributed along the circumference 205 of the rotor 202 in this example, the thicknesses can be at least one of linearly, logarithmically, or exponentially distributed along the circumference 205 in some examples.

In some examples, the seal segments 402 can have the same or substantially similar material properties (e.g., mass, density, material composition, etc.). In some examples, at least two of the seal segments 402 can have respective different masses, densities, and/or material compositions. In such examples, the seal segments 402 can have different natural frequencies resulting from the different material properties (e.g., in addition to the variations in radial thickness of the seal segments 402). In some examples, one or more different dimensions associated with the seal segments 402 (e.g., in addition to or instead of the thickness) can be adjusted to adjust the natural frequencies of adjacent seal segments 402.

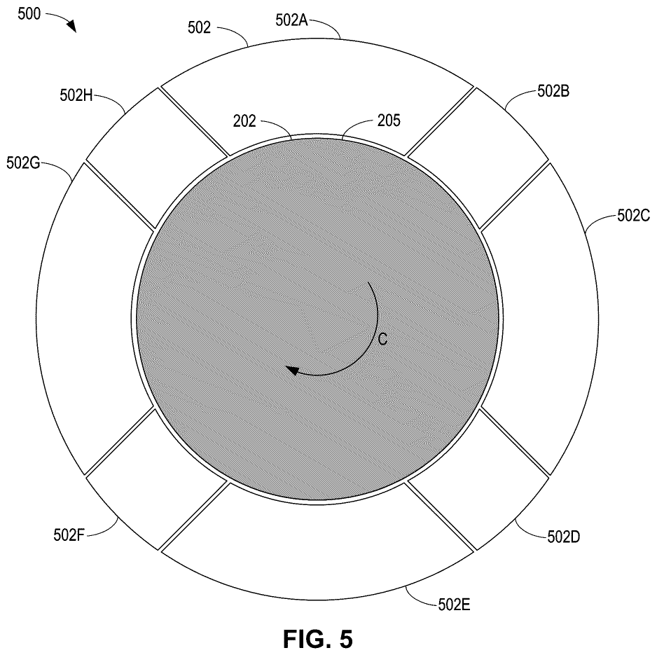

FIG. 5 illustrates a fourth example radial seal 500 that may be implemented on the rotor 202 of FIG. 2. In the illustrated example of FIG. 5, the fourth radial seal 500 includes eight example seal segments 502 (e.g., a first seal segment 502A, a second seal segment 502B, a third seal segment 502C, a fourth seal segment 502D, a fifth seal segment 502E, a sixth seal segment 502F, a seventh seal segment 502G, and an eighth seal segment 502H) spanning the circumference 205 of the rotor 202. In this example, widths (e.g., circumferential widths) of the seal segments 502 alternate in the circumferential direction C of the rotor 202. For example, adjacent seal segments 502 have different circumferential widths, but alternating seal segments 502 have substantially the same circumferential width.

In the illustrated example of FIG. 5, the first seal segment 502A, the third seal segment 502C, the fifth seal segment 502E, and the seventh seal segment 502G correspond to a first width, while the second seal segment 502B, the fourth seal segment 502D, the sixth seal segment 502F, and the eighth seal segment 502H correspond to a second width different from (e.g., less than) the first width. In such examples, as a result of adjacent seal segments 502 having different widths and, thus, different natural frequencies, vibration of the seal segments 502 is unlikely to excite or induce vibration between adjacent seal segments 502. Further, because the fourth radial seal 500 of FIG. 5 includes two different sizes of the seal segments 502, the fourth radial seal 500 is less complex and/or may be less costly to manufacture compared to a radial seal having seal segments with more than two different dimensions (e.g., the seal segments 302 of FIG. 3).

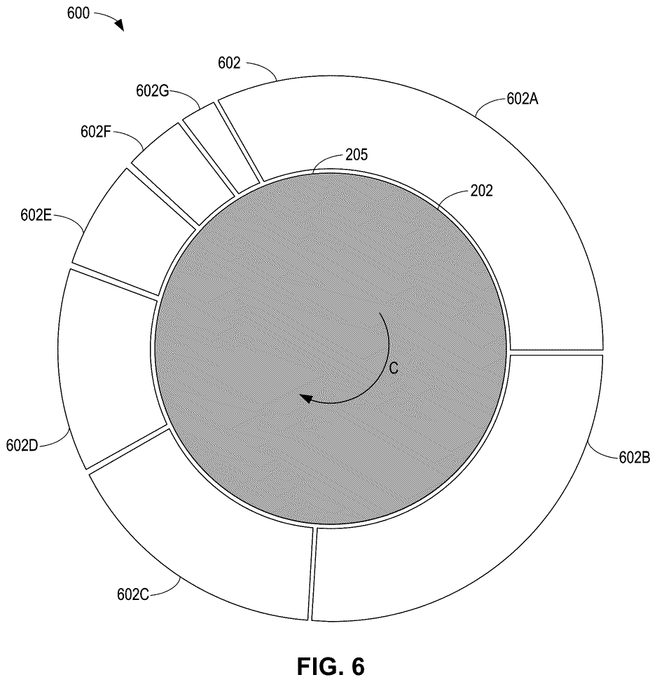

FIG. 6 illustrates a fifth example radial seal 600 that may be implemented on the rotor 202 of FIG. 2. In the illustrated example of FIG. 6, the fifth radial seal 600 includes seven example seal segments 602 (e.g., a first seal segment 602A, a second seal segment 602B, a third seal segment 602C, a fourth seal segment 602D, a fifth seal segment 602E, a sixth seal segment 602F, and a seventh seal segment 602G) spanning the circumference 205 of the rotor 202. In some examples, widths (e.g., circumferential widths) of the seal segments 502 vary in a graded pattern in the circumferential direction C of the rotor 202.

In the illustrated example of FIG. 6, the circumferential widths of the seal segments 602 decrease in the circumferential direction C between adjacent seal segments 602. For example, a first circumferential width of the first seal segment 602A is greater than a second circumferential width of the second seal segment 602B, the second circumferential width of the second seal segment 602B is greater than a third circumferential width of the third seal segment 602C, etc. Conversely, in some examples, the circumferential widths of the seal segments 602 can increase in the circumferential direction C between the adjacent seal segments 602. As a result of the variations in width, the adjacent seal segments 602 can have respective different natural frequencies, which can reduce and/or inhibit excitation of vibrations between the adjacent seal segments 602. While the circumferential widths of the seal segments 602 decrease in the circumferential direction C in this example, at least one dimension (e.g., length, width, thickness, etc.) and/or at least one material property (e.g., mass, density, etc.) can decrease between the seal segments 602 in the circumferential direction C.

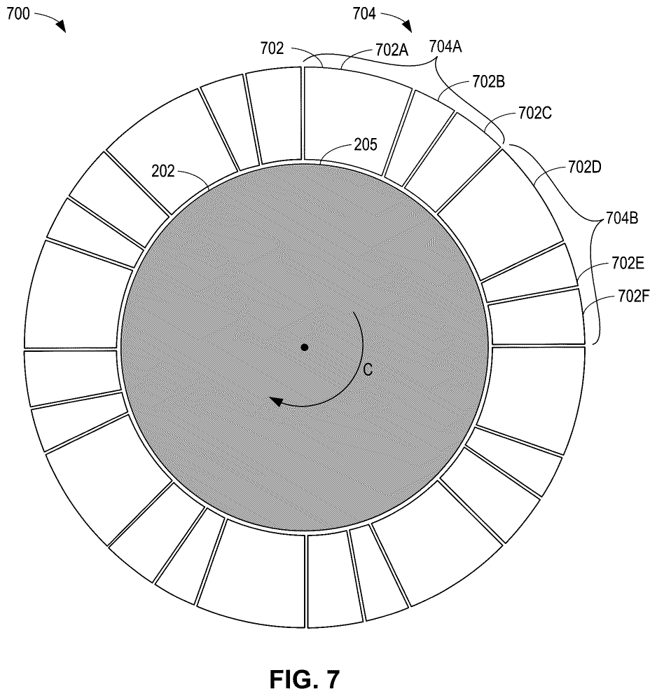

FIG. 7 illustrates a sixth example radial seal 700 that may be implemented on the rotor 202 of FIG. 2. The sixth radial seal 700 includes example seal segments 702 spanning the circumference 205 of the rotor 202. In the illustrated example of FIG. 7, a dimension (e.g., a circumferential width) of the seal segments 702 varies in a combined random and cyclical pattern about the circumference 205. For example, the seal segments 702 correspond to respective different subsets 704 (e.g., a first subset 704A, a second subset 704B, etc.) spanning the circumference 205. In some examples, a dimension of the seal segments 702 may be randomly distributed within a particular subset 704, and the subsets 704 repeat in the circumferential direction C about the rotor 202.

For example, in FIG. 7, the first subset 704A includes three of the seal segments 702 (e.g., a first seal segment 702A, a second seal segment 702B, and a third seal segment 702C). In this example, a dimension of the seal segments 702A, 702B, 702C is randomly distributed within the first subset 704A. While the dimension corresponds to a circumferential width in this example, the dimension can include a radial thickness (e.g., in the radial direction R) and/or an axial length (e.g., in the axial direction A) in some examples. Additionally or alternatively, a material property (e.g., a mass and/or a density) of the seal segments 702A, 702B, 702C may be randomly distributed within the corresponding first subset 704A. In some examples, a standard deviation of the dimension of the seal segments 702A, 702B, 702C are at least 5 percent and up to 100 percent of a mean value of the dimension of the seal segments 702A, 702B, 702C in the first subset 704A. While the dimension is randomly distributed in this example, the dimension can increase and/or decrease between the seal segments 702A, 702B, 702C (e.g., in the circumferential direction C) in some examples.

In the illustrated example of FIG. 7, the first subset 704A of the seal segments 702 repeats (e.g., in a cyclical pattern) about the rotor 202. For example, the sixth radial seal 700 includes the second subset 704B of the seal segments 702 adjacent to the first subset 704A, where the second subset 704B includes a fourth seal segment 702D, a fifth seal segment 702E, and a sixth seal segment 702F. In this example, the second subset 704B is substantially the same as the first subset 704A. For example, the fourth seal segment 702D of the second subset 704B is substantially the same as (e.g., has substantially the same dimensions and/or material properties as) the first seal segment 702A of the first subset 704A, the fifth seal segment 702E of the second subset 704B is substantially the same as the second seal segment 702B of the first subset 704A, and the sixth seal segment 702F of the second subset 704B is substantially the same as the third seal segment 702C of the first subset 704A. In some examples, as a result of the combined random and cyclical distribution of dimensions and/or material properties of the seal segments 702, adjacent seal segments 702 have respective different natural frequencies, which can reduce and/or inhibit excitation of vibrations between the adjacent seal segments 702. Further, by repeating the subsets 704 of the seal segments 702 about the circumference 205 of the rotor 202, the number of unique seal segments 702 to be produced may be reduced (e.g., compared to when the seal segments 702 have respective different dimensions along the circumference 205, as discussed in connection with FIG. 3). While three of the seal segments 702 are included per subset 704 in this example, the subsets 704 can include a different number of the seal segments 702 (e.g., two, four or more) in some examples.

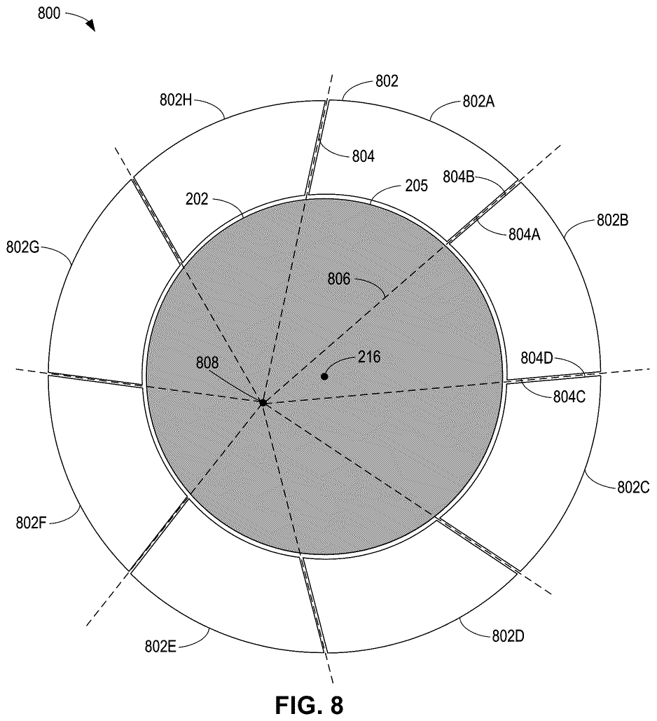

FIG. 8 illustrates a seventh example radial seal 800 that may be implemented on the rotor 202 of FIG. 2. In the illustrated example of FIG. 8, the seventh radial seal 800 includes example seal segments 802 (e.g., a first seal segment 802A, a second seal segment 802B, a third seal segment 802C, a fourth seal segment 802D, a fifth seal segment 802E, a sixth seal segment 802F, a seventh seal segment 802G, and an eighth seal segment 802H) spanning the circumference 205 of the rotor 202 and having an offset radius (e.g., a differential offset radius). In this example, the seal segments 802 include interfacing surfaces 804 facing adjacent seal segments 802. For example, a first interfacing surface 804A of the first seal segment 802A faces and/or is complementary to a second interfacing surface 804B of the second seal segment 802B, a third interfacing surface 804C of the second seal segment 802B faces and/or is complementary to a fourth interfacing surface 804D of the third seal segment 802C, etc.

In the illustrated example of FIG. 8, the interfacing surfaces 804 between corresponding pairs of adjacent seal segments 802 define example planes 806 between the adjacent seal segments 802. In this example, the planes 806 do not intersect at the longitudinal axis 216 of the rotor 202 (e.g., the planes 806 are offset from the longitudinal axis 216). Instead, in FIG. 8, the planes 806 intersect at an offset location (e.g., an offset point) 808 that is spaced apart from the longitudinal axis 216. As a result, the seal segments 802 have respective different dimensions and/or shapes and, thus, have respective different natural frequencies. As a result, the seal segments 802 can reduce and/or inhibit excitation of vibrations between the adjacent seal segments 602 (e.g., compared to when the planes 806 intersect at the longitudinal axis 216, such that the seal segments 802 have substantially the same dimensions and/or shape). In some examples, one or more of the planes 806 can intersect the longitudinal axis 216 and/or one or more different locations (e.g., different from the longitudinal axis 216 and/or the offset location 808).

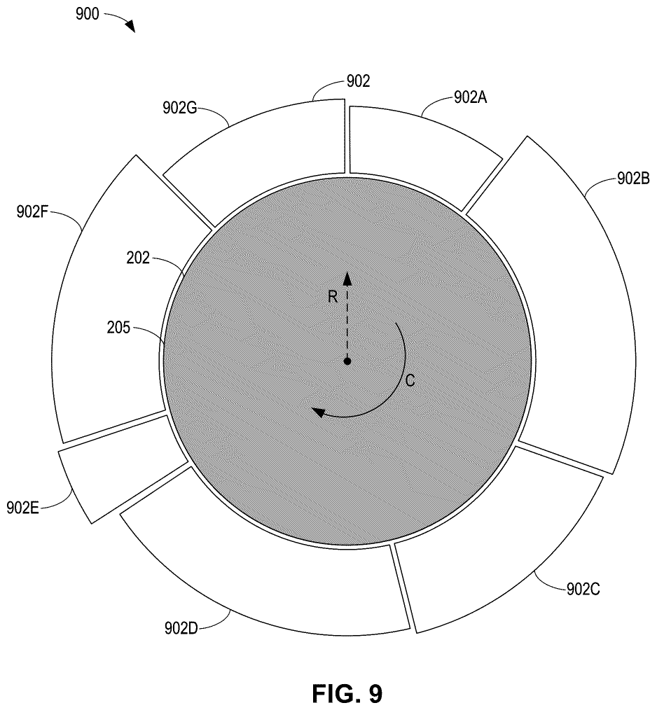

In some examples, a radial seal can be implemented using a combination of the techniques described herein for reducing vibration of seal segments. For example, FIG. 9 illustrates an eighth example radial seal 900 that may be implemented on the rotor 202 of FIG. 2. In the illustrated example of FIG. 9, the eighth radial seal 900 includes example seal segments 902 (e.g., a first seal segment 902A, a second seal segment 902B, a third seal segment 902C, a fourth seal segment 902D, a fifth seal segment 902E, a sixth seal segment 902F, and a seventh seal segment 902G) spanning the circumference 205 of the rotor 202. In this example, the eighth radial seal 900 includes a prime number (e.g., seven) of the seal segments 902. Further, the seal segments 902 have respective different circumferential widths (e.g., in the circumferential direction C) and respective different radial thicknesses (e.g., in the radial direction R). In some examples, the seal segments 902 can have respective different axial lengths (e.g., in an axial direction of the rotor 202 extending into and/or out of the page in FIG. 9). In this example, one or more of the dimensions (e.g., the circumferential widths, the radial thicknesses, and/or the axial lengths) are randomly distributed along the circumference 205, where a standard deviation of the dimensions are at least 5 percent and up to 100 percent of a mean value of the dimensions along the circumference 205. Additionally or alternatively, the dimension(s) can increase and/or decrease in a graded pattern along the circumference 205, can alternate along the circumference 205, and/or can be at least one of linearly, logarithmically, or exponentially distributed along the circumference 205. In some examples, at least one material property (e.g., mass, density, material composition, etc.) can differ between two more of the seal segments 902.

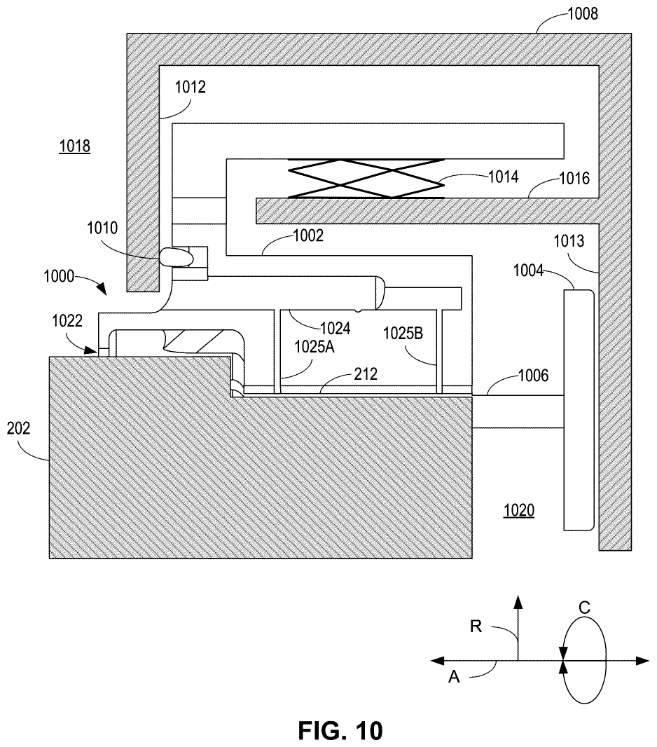

FIG. 10 is a cross-sectional view of one of an example seal segment 1000. The seal segment 1000 of FIG. 10 can correspond to one of the seal segments 204 of FIG. 2, the seal segments 302 of FIG. 3, the seal segments 402 of FIG. 4, the seal segments 502 of FIG. 5, the seal segments 602 of FIG. 6, the seal segments 702 of FIG. 7, the seal segments 802 of FIG. 8, and/or the seal segments 902 of FIG. 9. In the illustrated example of FIG. 10, the seal segment 1000 includes a first example seal body (e.g., a radial body) 1002, a second example seal body (e.g., an axial body) 1004, and an example pivot bar 1006 coupled and/or extending between the first seal body 1002 and the second seal body 1004. Further, an example stator (e.g., a carrier, a casing, a seal housing) 1008 (a portion of which is shown in FIG. 10) is positioned proximate to and/or surrounding a portion of the seal segment 1000. In this example, an example piston bar (e.g., a piston damper, a secondary seal) 1010 is positioned in the first seal body 1002 and contacts a first surface 1012 of the stator 1008. Further, the second seal body 1004 is adjacent and/or proximate to a second surface 1013 of the stator 1008 (e.g., opposite the first surface 1012), and an example retraction spring 1014 is operatively coupled between the seal segment 1000 and a third surface 1016 of the stator 1008. In this example, the film 212 of FIG. 2 is positioned between the seal segment 1000 and the rotor 202.

In the illustrated example of FIG. 10, the seal segment 1000 restricts flow and/or leakage of fluid between a high-pressure region 1018 and a low-pressure region 1020 of the gas turbine engine 106 of FIG. 1. For example, during operation of the gas turbine engine 106 (e.g., during rotation of the rotor 202 in the circumferential direction C), fluid from the high-pressure region 1018 can enter a gap 1022 between the first seal body 1002 and the rotor 202, where the film 212 restricts flow of the fluid and/or reduces a pressure of the fluid to the low-pressure region 1020. Additionally, high-pressure fluid can flow into a feedhole 1024 defined in the first seal body 1002, where the fluid can further flow from the feedhole 1024 to the film 212 via one or more fluid passageways 1025A, 1025B defined in the first seal body 1002. In some examples, the high-pressure fluid entering the first seal body 1002 (e.g., via the gap 1022 and/or via the feedhole 1024) results in a first radial force on the seal segment 1000 (e.g., in the radial direction R of FIG. 10). Additionally, the retraction spring 1014 can apply a second radial force on the seal segment 1000 (e.g., in and/or opposite to the radial direction R based on a distance between the seal segment 1000 and the third surface 1016 of the stator 1008). In some examples, a combination of the first and second radial forces on the seal segment 1000 results in a net radial force that enables the seal segment 1000 to follow and/or ride on a surface of the rotating rotor 202 without contacting the rotor 202.

In some examples, vibration of the rotor 202 and/or the seal segment 1000 may occur during operation of the gas turbine engine 106 of FIG. 1. In some examples, a response of the seal segment 1000 to vibratory loads is based on a natural frequency and/or a damping ratio associated with the seal segment 1000. In some examples, in addition to or instead of adjusting a dimension and/or material property of the seal segment 1000 to adjust the natural frequency (e.g., as discussed in connection with FIGS. 2-9 above), the natural frequency and/or damping ratio of the seal segment 1000 may be adjusted by adjusting (e.g., increasing or decreasing) a stiffness of the retraction spring 1014. In some examples, when multiple seal segments 1000 are positioned on the rotor 202 (e.g., spanning a circumference of the rotor 202), a stiffness of the retraction springs 1014 may be different between the different seal segments 1000. For example, adjacent seal segments 1000 can have respective different stiffnesses of the corresponding retraction springs 1014, resulting in respective different natural frequencies of the adjacent seal segments 1000.

In some examples, the natural frequency of the seal segment 1000 of FIG. 1 can be adjusted by adjusting a size, a position, an orientation, and/or a quantity of the fluid passageways 1025A, 1025B extending between the feedhole 1024 and the film 212. For example, the size (e.g., a cross-sectional dimension, a diameter) and/or the quantity of the fluid passageways 1025A, 1025B can be increased to increase an amount of high-pressure fluid to flow from the feedhole 1024 to the film 212, resulting in an increase in stiffness associated with the film 212. Conversely, the size and/or the quantity of the fluid passageways 1025A, 1025B can be decreased to reduce the amount of high-pressure fluid to flow from the feedhole 1024 to the film 212, resulting in a reduction of the stiffness associated with the film 212. For example, while two of the fluid passageways 1025A, 1025B are included in the seal segment 1000 of FIG. 10, a different number of the fluid passageways 1025A, 1025B (e.g., one, three or more) can be used instead.

In some examples, the natural frequency of the seal segment 1000 under vibratory loads is based, in part, on the stiffness of the film 212. Accordingly, the size, the position(s), the orientation(s), and/or the quantity of the fluid passageways 1025A, 1025B can be adjusted to adjust the stiffness of the film 212 and, thus, a natural frequency of the seal segment 1000. In some examples, when multiple seal segments 1000 are positioned on the rotor 202 (e.g., spanning a circumference of the rotor 202), the quantity and/or size of the fluid passageways 1025A, 1025B may be different between the different seal segments 1000. For example, adjacent seal segments 1000 can have respective different quantities and/or sizes of the fluid passageways 1025A, 1025B, resulting in respective different stiffnesses of the film 212 and, thus, respective different natural frequencies associated with the adjacent seal segments 1000. In some examples, a quantity, a size, an orientation, and/or a position of feedholes 1024 can be different between the adjacent seal segments 1000, such that the resulting natural frequencies are different between the seal segments. As a result of the differences in natural frequencies, vibration can be reduced and/or inhibited between the adjacent seal segments 1000.

In some examples, any suitable combination of the techniques described herein for reducing vibration of seal segments can be used. For example, radial seals can include a prime number of seal segments, and/or at least two of the seal segments (e.g., adjacent seal segments) can have respective different dimensions (e.g., a circumferential width, a radial thickness, an axial length, etc.) and/or material properties (e.g., a mass, a density, a material composition, etc.). Additionally, in some examples, the natural frequency of one or more seal segments can be adjusted by adjusting sizes and/or quantities of fluid passageways of the seal segments and/or adjusting stiffnesses of retraction springs of the seal segments. In some examples, one or more of the techniques may be selected for implementation in a radial seal based on relative complexity of manufacturing and/or maintaining the seal segments. For example, a radial seal with a prime number of seal segments and/or with different materials used for different seal segments may be relatively less complex to maintain and/or manufacture compared to, for example, a radial seal with seal segments having varying dimensions.

From the foregoing, it will be appreciated that example systems, apparatus, articles of manufacture, and methods have been disclosed that reduce (e.g., damp, dissipate) vibration of a radial seal (e.g., a hybrid radial seal) in a gas turbine engine. Examples disclosed herein can include a prime number of seal segments of the radial seal to inhibit excitation of vibration of adjacent seal segments. In some examples, the radial seal can include seal segments having respective different dimensions (e.g., circumferential width, radial thickness, axial length, etc.) and/or respective different material properties (e.g., mass, density, material composition, etc.), resulting in respective different natural frequencies of the seal segments. Additionally or alternatively, the natural frequencies of adjacent segments can be based on sizes and/or quantities of feedholes implemented in the adjacent seal segments, and/or based on stiffnesses of retraction springs of the adjacent seal segments.

By reducing vibration of one or more seal segments (and/or portions thereof), examples disclosed herein enable the seal segment(s) to more closely follow a surface of the rotor during operation and, as a result, may improve sealing performance of the radial seal. Further, by reducing vibrations, examples disclosed herein can reduce undesired contact between components of the gas turbine engine (e.g., between the rotor and one or more seal segments) and, thus, can reduce a likelihood of damage to one or more of the components during operation of the gas turbine engine. Disclosed systems, apparatus, articles of manufacture, and methods are accordingly directed to one or more improvement(s) in the operation of a machine and/or mechanical device.

Further disclosure is provided by the following clauses:

An apparatus for a gas turbine engine, the apparatus comprising a rotor, a stator, and a radial seal positioned between the rotor and the stator, the radial seal including a plurality of seal segments spanning a circumference of the rotor, a quantity of the plurality of seal segments corresponding to a prime number.

The apparatus of any preceding clause, wherein at least one of a dimension or a material property of the plurality of seal segments differs between at least two seal segments of the plurality of seal segments.

The apparatus of any preceding clause, wherein the dimension corresponds to at least one of a width along a circumferential direction of the rotor, a length along an axial direction of the rotor, or a thickness along a radial direction of the rotor.

The apparatus of any preceding clause, wherein the dimension is randomly distributed along the circumference, a standard of deviation of the dimension along the circumference is at least 5 percent and up to 100 percent of a mean value of the dimension along the circumference.

The apparatus of any preceding clause, wherein the material property corresponds to at least one of a mass, a density, or a material composition.

The apparatus of any preceding clause, wherein the mass is randomly distributed along the circumference, a standard deviation of the mass along the circumference is at least 5 percent and up to 20 percent of a mean value of the mass along the circumference.

The apparatus of any preceding clause, wherein the plurality of seal segments include a first seal segment, a second seal segment adjacent to the first seal segment, and a third seal segment adjacent to the second seal segment, the first and third seal segments having at least one of a first dimension or a first material property, the second seal segment having at least one of a second dimension or a second material property, the first dimension different from the second dimension, the first material property different from the second material property.

The apparatus of any preceding clause, wherein the at least one of the dimension or the material property decreases between the plurality of seal segments in a circumferential direction of the rotor.

The apparatus of any preceding clause, wherein the plurality of seal segments include first seal segments and second seal segments, the first seal segments adjacent to the second seal segments, the at least one of the dimension or the material property is randomly distributed across the first seal segments, the second seal segments substantially the same as the first seal segments.

The apparatus of any preceding clause, wherein a natural frequency of the plurality of seal segments is distributed at least one of linearly, logarithmically, or exponentially along the circumference.

The apparatus of any preceding clause, wherein the plurality of seal segments include a first seal segment and a second seal segment, the first seal segment adjacent to the second seal segment, further including a first retraction spring operatively coupled between the first seal segment and the stator, and a second retraction spring operatively coupled between the second seal segment and the stator, a first stiffness of the first retraction spring greater than a second stiffness of the second retraction spring.

An apparatus for a gas turbine engine, the apparatus comprising a rotor, a stator, and a radial seal positioned between the rotor and the stator, the radial seal including a plurality of seal segments spanning a circumference of the rotor, at least one of a dimension or a material property of the plurality of seal segments to differ between at least two seal segments of the plurality of seal segments.

The apparatus of any preceding clause, wherein the plurality of seal segments include a first seal segment and a second seal segment adjacent to the first seal segment, the first seal segment including an interfacing surface facing the second seal segment, the interfacing surface defining a plane, the plane offset from a longitudinal axis of the rotor.

The apparatus of any preceding clause, wherein a quantity of the plurality of seal segments is a prime number.

The apparatus of any preceding clause, wherein the at least one of the dimension or the material property alternates across the plurality of seal segments in a circumferential direction of the rotor.

The apparatus of any preceding clause, wherein the at least one of the dimension or the material property decreases across the plurality of seal segments in a circumferential direction of the rotor.

An apparatus for a gas turbine engine, the apparatus comprising a rotor, a stator, and a radial seal positioned between the rotor and the stator, the radial seal to restrict flow of fluid between a high-pressure region and a low-pressure region of the gas turbine engine, the radial seal including a plurality of seal segments spanning a circumference of the rotor, adjacent seal segments in the plurality of seal segments having respective different natural frequencies.

The apparatus of any preceding clause, further including a gas film positioned between the plurality of seal segments and the rotor, the plurality of seal segments including feedholes to supply the fluid from the high-pressure region to the gas film.

The apparatus of any preceding clause, wherein the plurality of seal segments include a first seal segment and a second seal segment adjacent to the first seal segment, the first seal segment including first ones of the feedholes, the second seal segment including second ones of the feedholes, at least one of a quantity, a dimension, a position, or an orientation of the feedholes to differ between the first ones of the feedholes and the second ones of the feedholes.

The apparatus of any preceding clause, wherein at least two of the plurality of seal segments have at least one of respective different dimensions or respective different material properties.

A gas turbine engine comprising a rotor, a stator, and a radial seal positioned between the rotor and the stator, the radial seal including a plurality of seal segments spanning a circumference of the rotor, at least one of a dimension or a material property of the plurality of seal segments to differ between at least two seal segments of the plurality of seal segments.

The gas turbine engine of any preceding clause, wherein a quantity of the plurality of seal segments corresponds to a prime number.

The gas turbine engine of any preceding clause, wherein the dimension corresponds to at least one of a width along a circumferential direction of the rotor, a length along an axial direction of the rotor, or a thickness along a radial direction of the rotor.

The gas turbine engine of any preceding clause, wherein the dimension is randomly distributed along the circumference, a standard of deviation of the dimension along the circumference is at least 5 percent and up to 100 percent of a mean value of the dimension along the circumference.

The gas turbine engine of any preceding clause, wherein the material property corresponds to at least one of a mass, a density, or a material composition.

The gas turbine engine of any preceding clause, wherein the mass is randomly distributed along the circumference, a standard deviation of the mass along the circumference is at least 5 percent and up to 20 percent of a mean value of the mass along the circumference.

The gas turbine engine of any preceding clause, wherein the plurality of seal segments include a first seal segment, a second seal segment adjacent to the first seal segment, and a third seal segment adjacent to the second seal segment, the first and third seal segments having at least one of a first dimension or a first material property, the second seal segment having at least one of a second dimension or a second material property, the first dimension different from the second dimension, the first material property different from the second material property.

The gas turbine engine of any preceding clause, wherein the at least one of the dimension or the material property decreases between the plurality of seal segments in a circumferential direction of the rotor.

The gas turbine engine of any preceding clause, wherein the plurality of seal segments include first seal segments and second seal segments, the first seal segments adjacent to the second seal segments, the at least one of the dimension or the material property is randomly distributed across the first seal segments, the second seal segments substantially the same as the first seal segments.

The gas turbine engine of any preceding clause, wherein a natural frequency of the plurality of seal segments is distributed at least one of linearly, logarithmically, or exponentially along the circumference.

The gas turbine engine of any preceding clause, wherein the plurality of seal segments include a first seal segment and a second seal segment, the first seal segment adjacent to the second seal segment, further including a first retraction spring operatively coupled between the first seal segment and the stator, and a second retraction spring operatively coupled between the second seal segment and the stator, a first stiffness of the first retraction spring greater than a second stiffness of the second retraction spring.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

1. An asymmetric radial seal apparatus for a gas turbine engine, the asymmetric radial seal apparatus comprising:
a rotor revolving at a rotational speed about a longitudinal axis of the rotor and having a number of vibrational loads during a single revolution of the rotor, the rotational speed and the number of vibrational loads defining a cyclic vibration experienced by the rotor during operation of the gas turbine engine;
and
a radial seal surrounding a circumference of the rotor, the radial seal including a plurality of seal segments, each having a natural frequency, wherein the plurality of seal segments is a prime number that is greater than or equal to three, the prime number differing from the number of vibrational loads during a single revolution of the rotor,
wherein the cyclic vibration experienced by the rotor imparts a vibrational load having a vibration frequency to each of the plurality of seal segments, and the prime number of seal segments reduces a likelihood of the vibration frequency matching the natural frequency of one of the plurality of seal segments.

2. The asymmetric radial seal apparatus of claim 1, wherein at least one of a dimension or a material property of the plurality of seal segments differs between at least two seal segments of the plurality of seal segments.

3. The asymmetric radial seal apparatus of claim 2, wherein the dimension corresponds to at least one of a width along a circumferential direction relative to the longitudinal axis, a length along an axial direction relative to the longitudinal axis or a thickness along a radial direction relative to the longitudinal axis.

4. The asymmetric radial seal apparatus of claim 2, wherein a standard deviation of the dimension of the plurality of seal segments arranged along the circumference of the rotor is in a range from five percent to one hundred percent, inclusive, of a mean value of the dimension of the plurality of seal segments along the circumference.

5. The asymmetric radial seal apparatus of claim 2, wherein the material property corresponds to at least one of a mass, a density, or a material composition.

6. The asymmetric radial seal apparatus of claim 5, wherein a standard deviation of the mass of the plurality of seal segments along the circumference of the rotor is in a range from five percent to twenty percent, inclusive, of a mean value of the mass of the plurality of seal segments along the circumference.

7. The asymmetric radial seal apparatus of claim 2, wherein the plurality of seal segments include a first seal segment, a second seal segment adjacent to the first seal segment, and a third seal segment adjacent to the second seal segment, the first and third seal segments having at least one of a first dimension or a first material property, the second seal segment having at least one of a second dimension or a second material property, the first dimension being different from the second dimension, and the first material property being different from the second material property.

8. The asymmetric radial seal apparatus of claim 2, wherein the at least one of the dimension or the material property continuously decreases between the plurality of seal segments in a circumferential direction relative to the longitudinal axis of the rotor.

9. The asymmetric radial seal apparatus of claim 2, wherein the plurality of seal segments include at least a first subset and a second subset, the first subset is positioned in a circumferential direction relative to the longitudinal axis adjacent to the second subset, the first subset including two or more seal segments, both the first subset and the second subset including two or more seal segments, the at least one of the dimension or the material property differing between at least two of the two or more seal segments in the first subset the second subset is substantially the same as the first subset.

10. The asymmetric radial seal apparatus of claim 1, wherein the natural frequency of the plurality of seal segments is distributed linearly, logarithmically, or exponentially along the circumference of the rotor.

11. The asymmetric radial seal apparatus of claim 1 further comprising a stator, wherein the plurality of seal segments include a first seal segment and a second seal segment, the first seal segment being arranged in a circumferential direction relative to the longitudinal axis adjacent to the second seal segment along the circumference of the rotor, and wherein a first retraction spring is operatively coupled between the first seal segment and the stator, a second retraction spring is operatively coupled between the second seal segment and the stator, and a first stiffness of the first retraction spring is greater than a second stiffness of the second retraction spring.

12-20. (canceled)

21. The asymmetric radial seal apparatus of claim 8, wherein the dimension continuously decreases linearly, logarithmically, or exponentially.

22. A turbine engine comprising:
a combustor that generates combustion gases;
a turbine that receives the combustion gases;
a rotor that is driven at a rotational speed by the turbine to revolve about a longitudinal axis, the rotor having a number of vibrational loads during a single revolution of the rotor, the rotational speed and the number of vibrational loads defining a cyclic vibration experienced by the rotor during operation of the turbine engine; and
a radial seal surrounding a circumference of the rotor, the radial seal including a plurality of seal segments, each having a natural frequency, wherein the plurality of seal segments is a prime number that is greater than or equal to three, the prime number differing from the number of vibrational loads during a single revolution of the rotor,
wherein the cyclic vibration experienced by the rotor imparts a vibrational load having a vibration frequency to each of the plurality of seal segments, and the prime number of seal segments reduces a likelihood of the vibration frequency matching the natural frequency of one of the plurality of seal segments.

23. The turbine engine of claim 22, wherein the plurality of seal segments include a first seal segment, a second seal segment adjacent to the first seal segment, and a third seal segment adjacent to the second seal segment, the first and third seal segments having at least one of a first dimension or a first material property, the second seal segment having at least one of a second dimension or a second material property, the first dimension being different from the second dimension, and the first material property being different from the second material property.

24. The turbine engine of claim 22, wherein at least one of a dimension or a material property continuously decreases between the plurality of seal segments in a circumferential direction relative to the longitudinal axis of the rotor.

25. The turbine engine of claim 22 further comprising a stator, wherein the plurality of seal segments include a first seal segment and a second seal segment, the first seal segment being arranged in a circumferential direction relative to the longitudinal axis adjacent to the second seal segment along the circumference of the rotor, and wherein a first retraction spring is operatively coupled between the first seal segment and the stator, a second retraction spring is operatively coupled between the second seal segment and the stator, and a first stiffness of the first retraction spring is greater than a second stiffness of the second retraction spring.

26. The turbine engine of claim 22, wherein at least one of a dimension of the plurality of seal segments differs between at least two seal segments, and a standard of deviation of the dimension of the plurality of seal segments arranged along the circumference of the rotor is in a range from five percent to one hundred percent, inclusive, of a mean value of the dimension of the plurality of seal segments along the circumference.

27. The turbine engine of claim 26, wherein the dimension corresponds to at least one of a width along a circumferential direction relative to the longitudinal axis, a length along an axial direction relative to the longitudinal axis, or a thickness along a radial direction relative to the longitudinal axis.

28. The turbine engine of claim 22, wherein at least one of a material property of the plurality of seal segments differs between at least two seal segments of the plurality of seal segments, and the material property corresponds to at least one of a mass, a density, or a material composition.

29. The turbine engine of claim 28, wherein a standard deviation of the mass of the plurality of seal segments along the circumference of the rotor is in a range from five percent to twenty percent, inclusive, of a mean value of the mass of the plurality of seal segments along the circumference.
